(19) United States
(12) Patent Application Publication
(10) Pub. No.: US 2011/0317023 A1
(43) Pub. Date: Dec. 29, 2011

(54) ELECTRONIC DEVICE

(75) Inventors: Yoshiyuki TSUDA, Hirakata City (JP); Kaihei Kuwata, Kyoto City (JP)

(73) Assignee: SANYO Electric Co., Ltd., Moriguchi City (JP)

(21) Appl. No.: 13/169,421

(22) Filed: Jun. 27, 2011

(30) Foreign Application Priority Data
Jun. 29, 2010 (JP) 2010-148133

(51) Int. Cl. H04N 5/225

(52) U.S. Cl. 348/207.99; 348/E05.024

(57) ABSTRACT

An electronic device has a sound signal processing portion which applies sound signal processing to a target sound signal corresponding to a target image. The sound signal processing portion controls the content of the sound signal processing in accordance with the focus condition of the target image.

This nonprovisional application claims priority under 35 U.S.C. §119(a) on Patent Application No. 2010-148133 filed in Japan on Jun. 29, 2010, the entire contents of which are hereby incorporated by reference.

### BACKGROUND OF THE INVENTION

1. Field of the Invention

The present invention relates to an electronic device such as a digital camera.

2. Description of Related Art

Electronic devices, such as digital cameras, that can record and replay audio along with video are in wide use. In electronic devices of this type, there have been proposed methods of recording or replaying audio with directivity in a particular direction.

For example, in a video camera that adopts a first conventional method, while an image being shot is displayed on a display screen, the directivity of a microphone array is set in a direction corresponding to a position indicated by the user on the display screen.

For another example, according to a second conventional method, a direction in which a subject (for example, a person) of a particular type is located is detected, and the directivity of recorded audio or the like is controlled in accordance with the detected direction.

With the first conventional method, it is certainly possible to give recorded or replayed audio directivity that matches the user's preference. However, determining the direction of directivity requires an instruction from the user, and this leads to increased operation burden on the user.

On the other hand, with the second conventional method, it is certainly possible, without waiting for an instruction from the user, to set directivity in a direction of a subject of a particular type that is expected to attract the user's interest. However, the second conventional method functions effectively only when a subject of a particular type is located inside a shooting range; that is, if a subject of a type other than the particular type is attracting the user's interest, directivity control does not function effectively.

### SUMMARY OF THE INVENTION

According to the present invention, in an electronic device provided with a sound signal processing portion which applies sound signal processing to a target sound signal corresponding to a target image, the sound signal processing portion controls the content of the sound signal processing in accordance with the focus condition of the target image.

### BRIEF DESCRIPTION OF THE DRAWINGS

FIG. 1 is a schematic overall block diagram of an image shooting apparatus according to Embodiment 1 of the invention;

FIG. 2 is an internal configuration diagram of the image shooting portion shown in FIG. 1;

FIG. 3 is a diagram showing the internal configuration of the microphone portion shown in FIG. 1 and the circuit connected to the microphone portion;

FIG. 4 is an external perspective view of the image shooting apparatus shown in FIG. 1;

FIGS. 5A and 5B are diagrams showing the polar patterns of sound signals that can be generated at the sound signal processing portion shown in FIG. 1, and FIG. 5C is a diagram illustrating the definition of the angle of a given sound source;

FIG. 6 is a block diagram of part of the mage shooting apparatus according to Embodiment 1 of the invention;

FIGS. 7A and 7B are diagrams showing the relationship between a target input image and a target sound collection period in which to collect a target sound signal;

FIG. 8 is a diagram showing three areas defined in real space;

FIG. 9 is a diagram showing how a target input image is divided into three parts;

FIG. 10 is a diagram clarifying the definitions of depth of field, in-focus distance, and subject distance;

FIGS. 11A to 11D are conceptual diagrams showing examples of the relationship between a target input image and a playback sound signal;

FIG. 12 is a flow chart of operation for generating a playback sound signal in Embodiment 1 of the invention;

FIG. 13 is a block diagram of part of an image shooting apparatus according to Embodiment 2 of the invention;

FIG. 14 is a diagram showing a target input image referred to in specific examples in Embodiment 2 of the invention;

FIG. 15 is a diagram showing the relationship among the distances from three subjects to the image shooting apparatus in Embodiment 2 of the invention; and

FIGS. 16A to 16C are diagrams showing first to third patterns of digital focusing in Embodiment 2 of the invention.

### DETAILED DESCRIPTION OF PREFERRED EMBODIMENTS

Hereinafter, embodiments of the present invention will be described specifically with reference to the accompanying drawings. Among the different drawings referred to, the same parts are identified by the same reference signs, and in principle no overlapping description of the same parts will be repeated.

### Embodiment 1

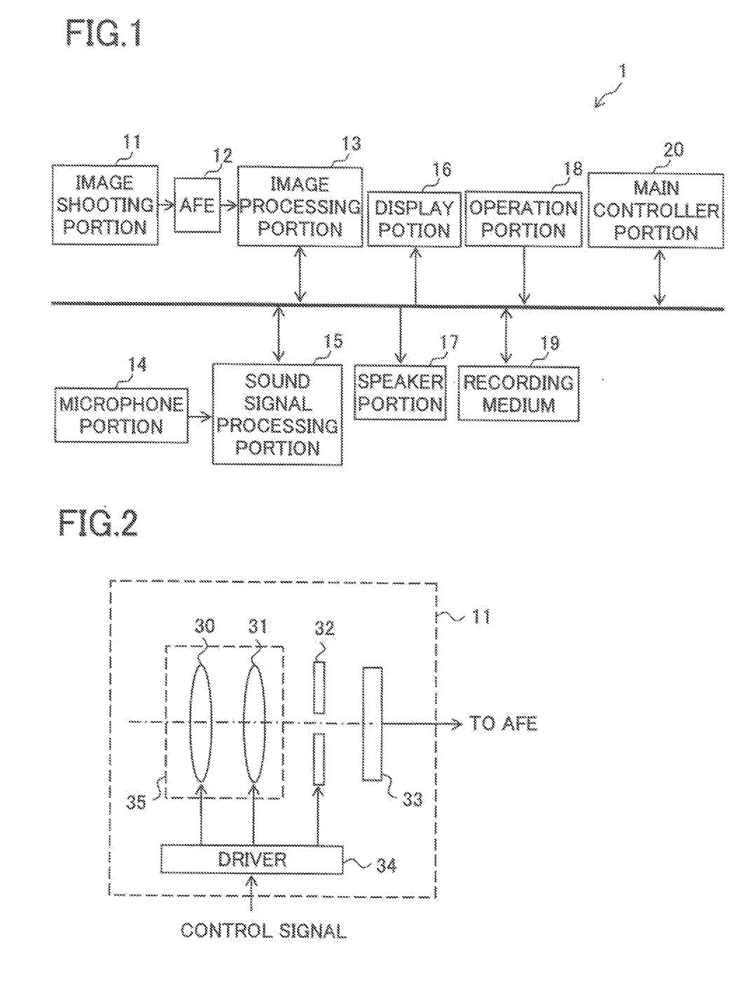

A first embodiment (Embodiment 1) of the invention will be described. FIG. 1 is a schematic overall block diagram of an image shooting apparatus 1 according to Embodiment 1. The image shooting apparatus 1 is a digital still camera that can take and record still images, or a digital video camera that can take and record still and moving images. The image shooting apparatus 1 may be one that is incorporated in a portable terminal such as a cellular phone.

The image shooting apparatus 1 is provided with an image shooting portion 11, an AFE 12, an image processing portion 13, a microphone portion 14, a sound signal processing portion 15, a display potion 16, a speaker portion 17, an operation portion 18, a recording medium 19, and a main controller portion 20.

FIG. 2 is an internal configuration diagram of the image shooting portion 11. The image shooting portion 11 includes an optical system 35, an aperture stop 32, an image sensor 33 constituted by a CCD (charge-coupled device) image sensor, a CMOS (complementary metal oxide semiconductor) image sensor, or the like, and a driver 34 for driving and controlling the optical system 35 and the aperture stop 32. The optical system 35 is composed of a plurality of lenses including a zoom lens 30 and a focus lens 31. The zoom lens 30 and the focus lens 31 are movable in the optical axis direction. The driver 34 drives the zoom lens 30 and the focus lens 31 to control their position, and drives the aperture stop 32 to control its aperture size, on the basis of control signals from the main controller portion 20; the driver 34 thereby controls the focal length (angle of view) and focal position of the image shooting portion 11 and the amount of light incident on the image sensor 33 (in other words, the aperture value).

The image sensor 33 photoelectrically converts the optical image representing a subject that is incident on it via the optical system 35 and the aperture stop 32, and outputs the electrical signal resulting from the photoelectric conversion to the AFE 12. The AFE 12 amplifies the analog signal output from the image shooting portion 11 (image sensor 33), and converts the amplified analog signal into a digital signal. The AFE 12 outputs the digital signal as RAW data to the image processing portion 13. The amplification factor at the AFE 12 is controlled by the main controller portion 20.

The image processing portion 13 generates image data representing the image shot by the image shooting portion 11 (hereinafter also referred to as the shot image) on the basis of the RAW data from the AFE 12. The image data generated here contains, for example, luminance signals and color-difference signals. It should be understood that RAW data itself is a type of image data, and that the analog signal output from the image shooting portion 11 too is a type of image data.

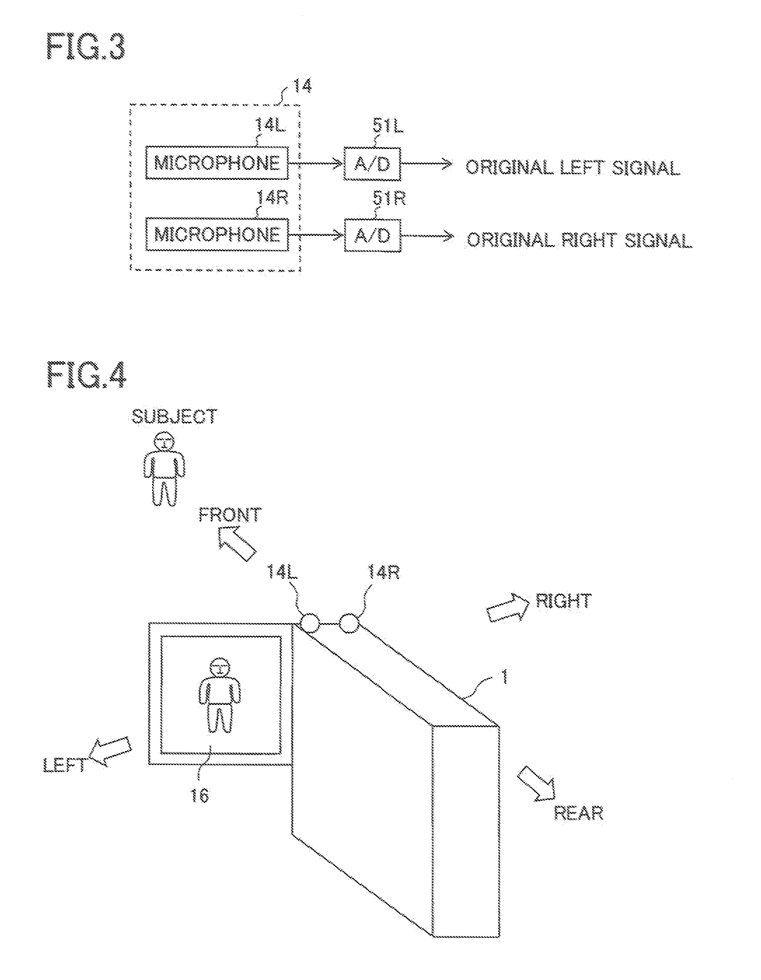

The microphone portion 14 converts sound from around the image shooting apparatus 1 into a sound signal. The microphone portion 14 may be composed of a plurality of microphones. Here, it is assumed that, as shown in FIG. 3, the microphone portion 14 is composed of two microphones 14L and 14R. A/D (analog-to-digital) converters 51L and 51R may be provided in the sound signal processing portion 15. FIG. 4 is an exterior perspective view of the image shooting apparatus I. The microphones 14L and 14R are arranged at different positions on the body of the image shooting apparatus 1. FIG. 4 also shows an object shot by the image shooting apparatus 1, that is, a subject of the image shooting apparatus 1. A shot image of the subject is displayed on the display potion 16, and this enables the user to confirm the shooting range etc. of the image shooting apparatus 1.

As shown in FIG. 4, the direction in which a subject that can be shot by the image shooting apparatus 1 is located is defined as the front direction, and the opposite direction is defined as the rear direction. The front and rear directions align with the optical axis of the image shooting portion 11. It is moreover assumed that the right and left sides refer to those sides as viewed by someone looking from rear to front.

The microphones 14L and 14R each covert the sound they have collected into an analog sound signal and output it. The A/D converters 51L and 51R in FIG. 3 each convert the analog sound signal output from the corresponding microphones 14L and 14R into a digital sound signal at a predetermined sampling period (for example, 48 kilohertz) and output it. The output signal of the A/D converter 51L is specifically called the original left signal, and the output signal of the A/D converter 51R is specifically called the original right signal.

The sound signal processing portion 15 can perform necessary sound signal processing on the original left and right signals. The particulars of the processing will be described later.

The display potion 16 is a display device that has a display screen constituted by a liquid crystal display panel or the like, and under the control of the main controller portion 20, displays a shot image, an image recorded on the recording medium 19, etc. The speaker portion 17 is composed of one or more than one speaker, and outputs sound by reproducing it from a desired sound signal such as the output sound signal of the microphone portion 14, the sound signal generated at the sound signal processing portion 15, or a sound signal read out from the recording medium 19. The operation portion 18 accepts various kinds of operation by the user. How the operation portion 18 is operated is transmitted to the main controller portion 20 etc. The recording medium 19 is a non-volatile memory such as a card-type semiconductor memory or a magnetic disk, and under the control of the main controller portion 20, records a shot image etc. The main controller portion 20 controls the operation of the individual blocks in the image shooting apparatus 1 in a concentrated fashion in accordance with how the operation portion 18 is operated.

The image shooting apparatus 1 can operate in different operation modes including a shooting mode, in which it can shoot a still or moving image, and a playback mode, in which it can replay on the display potion 16 a still or moving image recorded on the recording medium 19. In the shooting mode, the subject is shot periodically at predetermined frame periods, and the image shooting portion 11 (more specifically, the AFE 12) outputs RAW data representing a sequence of shot images (shot image sequence) of the subject. An image sequence, as exemplified by a shot image sequence here, denotes a series of chronologically ordered images. Image data worth one frame period represents one image. One shot image represented by image data worth one frame period from the AFE 12 is also referred to as a frame image. A frame image may also be understood to be an image that is obtained by applying predetermined image processing (demosaicing, noise elimination, color compensation, etc.) to a shot image represented by RAW data.

As the microphones 14L and 14R, non-directional microphones having no directivity may be adopted. In a case where the microphones 14L and 14R are non-directional microphones, the original left and right signals are non-directional sound signals (sound signal having no directivity). The sound signal processing portion 15 can generate from the non-directional original left and right signals a sound signal having an axis of directivity in a desired direction by use of well-known directivity control.

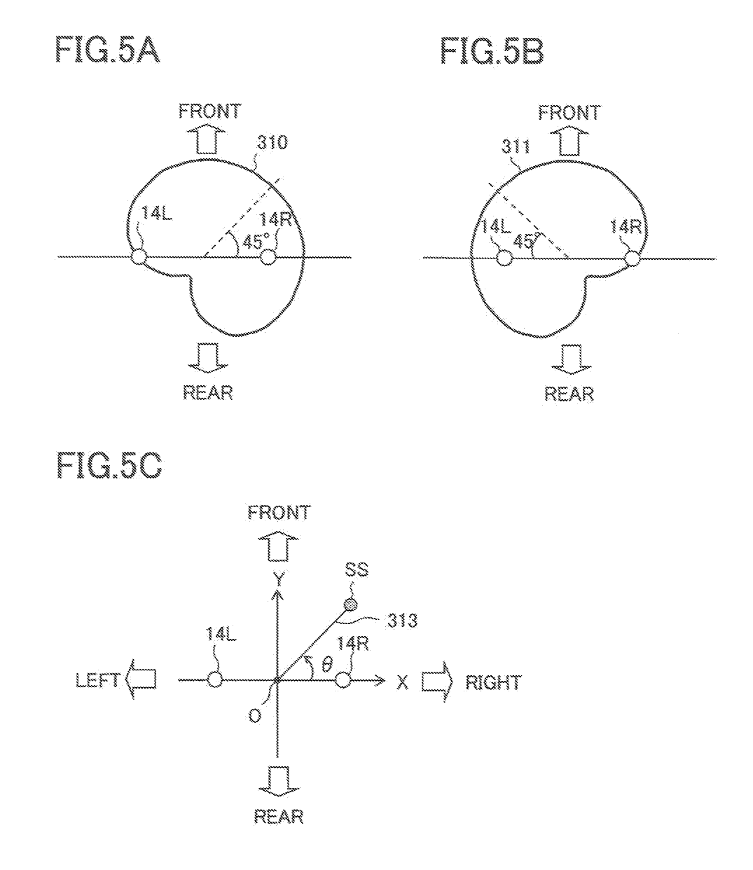

The directivity control can be achieved through the following stages of processing: delaying, whereby the original left or right signal is delayed; attenuation, whereby the original left or right signal is attenuated by a predetermined factor; and subtraction, whereby from one of the original left and right signals that has undergone delaying and/or attenuation, the other is subtracted. Specifically, for example, by delaying the original left signal by the length of time based on the distance between the microphones 14L and 14R, then attenuating the result by a predetermined factor, and then subtracting the result from the original right signal, it is possible to generate a sound signal that has a polar pattern 310 shown in FIG. 5A, that is, a sound signal that has a blind spot in a direction of 45° to the rear left. A sound signal having the polar pattern 310 is a sound signal having an axis of directivity in a direction of 45° to the front right. That is, it is a sound signal that exhibits the highest directivity (sensitivity) to a sound component reaching the image shooting apparatus 1 from a sound source located at 45° to the front right with respect to the image shooting apparatus 1. Likewise, by delaying the original right signal by the length of time based on the distance between the microphones 14L and 14R, then attenuating the result by a predetermined factor, and then subtracting the result from the original left signal, it is possible to generate a sound signal that has a polar pattern 311 shown in FIG. 5B, that is, a sound signal that has a blind spot in a direction of 45° to the rear right. A sound signal having the polar pattern 311 is a sound signal having an axis of directivity in a direction of 45° to the front left. That is, it is a sound signal that exhibits the highest directivity (sensitivity) to a sound component reaching the image shooting apparatus 1 from a sound source located at 45° to the front left with respect to the image shooting apparatus 1.

Consider an XY coordinate plane (XY coordinate system) having X and Y axes as coordinate axes as shown in FIG. 5C. The X axis passes through the center of the microphone 14L and the center of the microphone 14R, and at the midpoint between their centers is located an origin O. The Y axis perpendicularly intersects the X axis at the origin O. The Y axis aligns with the direction of the optical axis of the image shooting portion 11 (the optical axis with respect to the image sensor 33). The X and Y axes are assumed to be parallel to the horizontal plane. The direction from the origin O toward the microphone 14R (that is, the direction to the right of the image shooting apparatus 1) is assumed to be the positive X direction, and the direction from the origin O frontward of the image shooting apparatus 1 is assumed to be the positive Y direction. A line segment 313 connects between the origin O and a given sound source SS. The angle from the X axis to the line segment 313 is represented by θ. Here, it is assumed that the angle θ is the angle between the X axis and the line segment 313 as measured counter-clockwise from the line segment connecting between the origin O and the center of the microphone 14R. Counter-clockwise denotes the direction in which the line segment extending from the origin O to the center of the microphone 14R is rotated frontward of the image shooting apparatus 1. The angle θ of the sound source SS represents the direction in which the sound source SS is located (that is, the sound source direction with respect to the sound source SS).

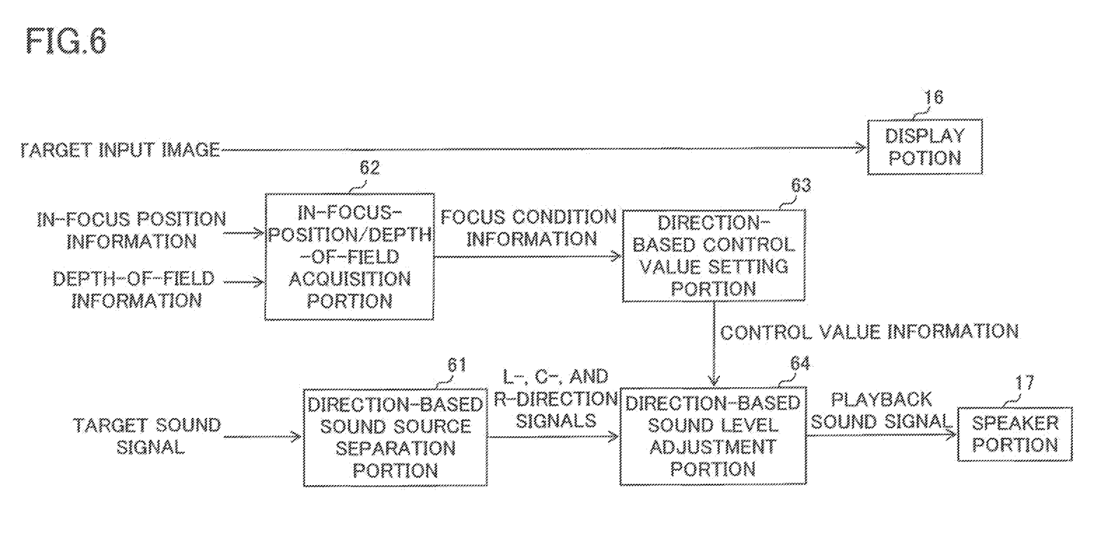

The image shooting apparatus 1 is provided with a function of applying special sound signal processing in accordance with the condition of focus. This function will now be described in detail. FIG. 6 is a block diagram of the blocks particularly involved in the realization of the function. A direction-based sound source separation portion 61, a direction-based control value setting portion 63, and a direction-based sound level adjustment portion 64 may be provided in the sound signal processing portion 15 in FIG. 1. An in-focus-position/depth-of-field acquisition portion 62 is realized by the image processing portion 13 and/or the main controller portion 20.

The direction-based sound source separation portion 61 (hereinafter often abbreviated to the sound source separation portion 61) generates first to mth direction signals from a target sound signal. Here, m is an integer of 2 or more. The target sound signal is a sound signal composed of the original left and right signals. The direction signals are each a sound signal extracted from the target sound signal and having directivity, and let i and j be different integers, then the ith and jth direction signals have directivity in different directions. In the following description, it is assumed, unless otherwise stated, that m=3, and that generated as the first, second, and third direction signals are L-, C-, and R-direction signals respectively.

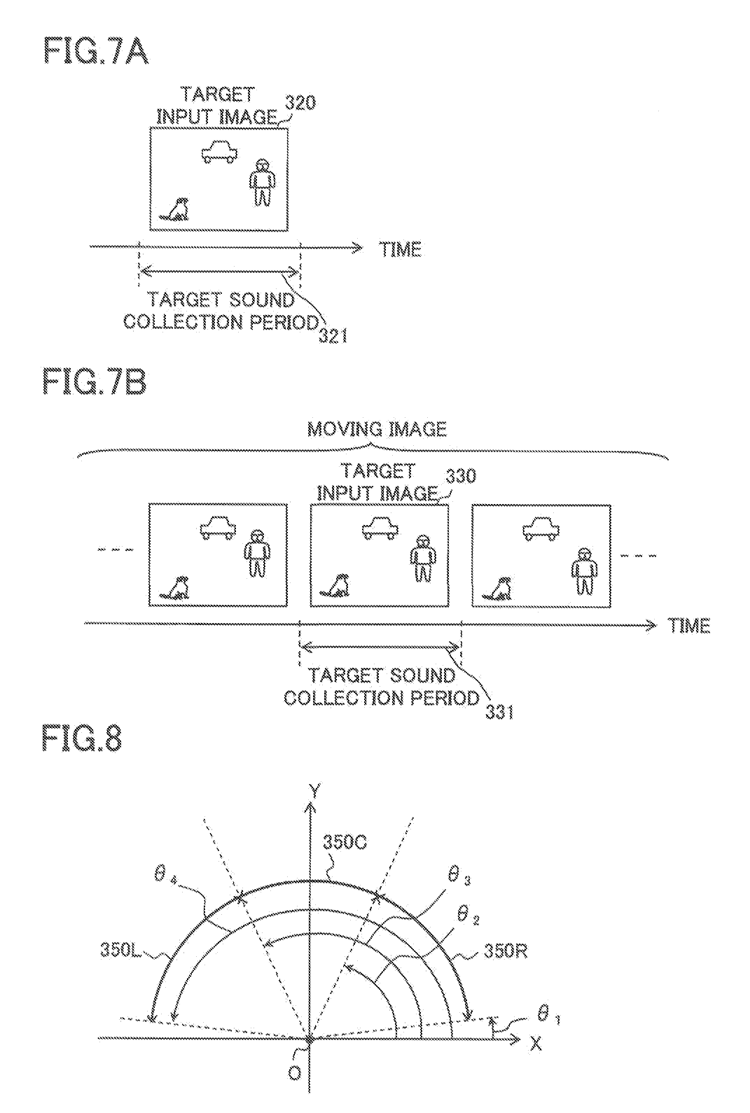

The target sound signal is a sound signal that is associated with a target input image. The target input image is, for example, one frame image as a still image that is obtained in response to an instruction to shoot a still image. When the target input image is a still image, as shown in FIG. 7A, the target input image 320 as a still image is allocated a target sound collection period 321, and from the output sound signal of the microphone portion 14 during the target sound collection period 321 (in this example, the original left and right signals), a target sound signal corresponding to the target input image 320 is generated. The target sound collection period 321 is a period relative to the time point at which the target input image 320 is shot, and let time point s be the middle time point during the exposure period of the target input image 320, then the target sound collection period 321 is, for example, the period from time point (s−Δs_{A}) to time point (s+Δs_{B}). Time point (s−Δs_{A}) is the time point a length of time Δs_{A} before the time point s, and time point (s+Δs_{B}) is the time point a length of time Δs_{B} after the time point s. The lengths of time Δs_{A} and Δs_{B} are both positive lengths of time. One of Δs_{A} and Δs_{B} may be zero.

The target input image may instead be a desired frame image among those constituting a moving image. When the target input image is a frame image in a moving image, as shown in FIG. 7B, the target input image 330 as a frame image is allocated a target sound collection period 331, and from the output sound signal of the microphone portion 14 during the target sound collection period 331 (in this example, the original left and right signals), a target sound signal corresponding to the target input image 330 is generated. The target sound collection period 331 is a period relative to the time point at which the target input image 330 is shot, and let time point s be the middle time point during the exposure period of the target input image 330, then the target sound collection period 331 is, for example, the period from time point (s−Δs_{A}) to time point (s+Δs_{B}), or the frame period corresponding to the target input image 330.

Now, with reference to FIG. 8, the definitions of the different direction signals will be presented. The L-direction signal is a sound signal that is obtained by separating and extracting, from the target sound signal, a sound component that has reached the image shooting apparatus 1 from a sound source located in area 350L. The C-direction signal is a sound signal that is obtained by separating and extracting, from the target sound signal, a sound component that has reached the image shooting apparatus 1 from a sound source located in area 350C. The R-direction signal is a sound signal that is obtained by separating and extracting, from the target sound signal, a sound component that has reached the image shooting apparatus 1 from a sound source located in area 350R.

Areas 350L, 350C, and 350R are different areas in real space.

Area 350L is an area where a sound source SS having an angle θ fulfilling the inequality “θ₃=θ<θ₄” is located.

Area 350C is an area where a sound source SS having an angle θ fulfilling the inequality “θ₂=θ<θ₃” is located.

Area 350R is an area where a sound source SS having an angle θ fulfilling the inequality “θ₁=θ<θ₂” is located. Here, the inequality “0°=θ₁<θ₂<90°<θ₃<θ₄=180°” is fulfilled. The angle θ₁ may be a negative angle, and the angle θ₄ may be an angle larger than 180°.

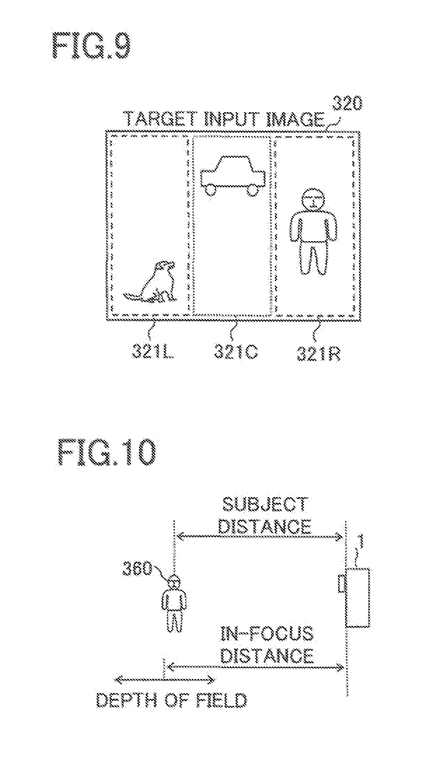

The specific values of the angles θ₁, θ₂, θ₃, and θ₄ can be determined in accordance with the angle of view of the target input image. For example, when the direction signals with respect to the target input image 320 in FIG. 7A are generated, the entire image region of the target input image 320 is split into divided image regions 321L, 321C, and 321R as shown in FIG. 9, and the specific values of the angles θ₁, θ₂, θ₃, and θ₄ are determined in accordance with the angle of view during the shooting of the target input image 320 such that a subject as a sound source located in the divided image region 321L falls within area 350L, in addition that a subject as a sound source located in the divided image region 321C falls within area 350C, and in addition that a subject as a sound source located in the divided image region 321R falls within area 350R. A similar description applies to the target input image 330 in FIG. 7B. Here, it is assumed that the divided image regions 321L, 321C, and 321R are obtained by splitting the entire image region of the target input image 320 along its vertical direction into three parts, and that, in the image space of the target input image 320, and in real space as well, a subject in the divided image region 321L is located to the left of a subject in the divided image region 321C, and a subject in the divided image region 321R is located to the right of a subject in the divided image region 321C (a similar description applies to the target input image 330 in FIG. 7B).

The sound source separation portion 61 can generate L-, C-, and R-direction signals from the target sound signal by use of the directivity control described above. Although the L-direction signal is defined to be “a sound signal obtained by separating and extracting, from the target sound signal, a sound component that has reached the image shooting apparatus 1 from a sound source located in area 350L” above, depending on the characteristics of the directivity control, a sound component from a sound source located outside area 350L may mix with the L-direction signal (a similar description applies to the C- and R-direction signals). Therefore, the L-direction signal may instead be defined to be a sound signal that exhibits higher sensitivity in the direction of a sound source SS fulfilling “θ₃=θ<θ₄” than in the direction of a sound source SS not fulfilling “θ₃=θ<θ₄ (a similar description applies to the C- and R-direction signals).

The in-focus-position/depth-of-field acquisition portion 62 (hereinafter often abbreviated to the acquisition portion 62) in FIG. 6 acquires the in-focus position and depth of field of the target input image.

With respect to a given two-dimensional image, the in-focus position of that two-dimensional image denotes the position on it of the in-focus region included in the entire image region of the two-dimensional image. Thus, the in-focus position may be referred to as the position of the in-focus region. The in-focus position is thus assumed to be information conveying not only the center position of the in-focus region but also the horizontal and vertical dimensions of the in-focus region. Accordingly, for example, in a case where the in-focus region is a rectangular region, the in-focus position is information that identifies the positions of the upper left and lower right corners of the in-focus region.

The in-focus region is an image region where the image data of a subject in focus is present. As is well known (see FIG. 10), during the shooting of the target input image, a subject 360 located within the depth of field is in focus, and the subject 360 in focus appears inside the in-focus region. Here, the subject distance of the subject 360 is within the depth of field. The subject distance of a given subject denotes the distance between the subject and the image shooting apparatus 1 (more specifically, the image sensor 33) in real space.

The in-focus region may instead be thought of as an image region where the degree of focus is comparatively high (for example, an image region where the degree of focus is higher than a predetermined reference degree of focus). An “image region where the image data of a subject in focus is present” is a kind of “image region where the degree of focus is comparatively high.” The degree of focus indicates how sharp focus is achieved. It is considered that the higher the degree of focus with respect to a region of interest, or pixels of interest, the sharper focus the subject in the region of interest, or at the pixels of interest, is in. The light from a subject of interest as a point light source forms a point image on the image sensor 33 and on the target input image. The smaller the diameter of the point image, the higher the degree of focus in the region where the image data of the subject of interest is present; the larger the diameter of the point image, the lower the degree of focus in the region where the image data of the subject of interest is present.

The distance from the image shooting apparatus 1 to the center within the depth of field is called the in-focus distance (see FIG. 10). The in-focus distance of the target input image can be determined from the condition of the individual lenses (in particular, the position of the focus lens 31) in the optical system 35 during the shooting of the target input image.

The acquisition portion 62 can detect the in-focus region in the target input image on the basis of in-focus position information. When it detects the in-focus region, it detects the in-focus position at the same time.

The in-focus position information is, for example, the image data of the target input image. Methods of detecting the in-focus region and in-focus position from the image data of the target input image are well-known, and the acquisition portion 62 can use any of those well-known detection methods. Typically, for example, a contrast-based detection method is used. Specifically, for example, a plurality of evaluation regions different from one another are set in the entire image region of the target input image, and for each evaluation region, the high-frequency components in the spatial frequency components of the image inside the evaluation region are extracted; then any evaluation region for which the amount of extracted high-frequency components is larger than a predetermined reference amount is recognized as an in-focus region. The amount of high-frequency components extracted for each evaluation region may be thought of as the degree of focus calculated for each evaluation region. Depending on the subject distances of different subjects and the depth of field, two or more evaluation regions may be recognized as in-focus regions; the entire image region of the target input image may be recognized as an in-focus region.

Alternatively, for example, distance measurement (range finding) may be performed to measure the subject distances of different subjects in the shooting range of the image shooting apparatus 1 so as to detect the in-focus region and the in-focus position by use of the results of the distance measurement. By converting the results of the distance measurement into a range image in which each pixel value is a measured subject distance, and using the range image, the in-focus distance, and the depth of field (the interval between the near and far ends of the depth of field) as in-focus position information, it is possible to identify what part of the target input image is an in-focus region.

The acquisition portion 62 can detect the depth of field (the interval between the near and far ends of the depth of field) of the target input image on the basis of depth-of-field information. As the depth-of-field information, the aperture value and focal length during the shooting of the target input image can be used. This is because once the aperture value and focal length during the shooting of the target input image are determined, the depth of field (the interval between the near and far ends of the depth of field) of the target input image is determined.

The acquisition portion 62 outputs focus condition information which indicates the condition of focus of the target input image. The focus condition information contains information conveying the in-focus position and depth of field (the interval between the near and far ends of the depth of field) of the target input image.

The direction-based control value setting portion 63 (hereinafter often abbreviated to the control value setting portion 63) sets control values for the L-, C-, and R-direction signals respectively on the basis of the focus condition information, and outputs control value information conveying the control values for the L-, C-, and R-direction signals. The direction-based sound level adjustment portion 64 (hereinafter often abbreviated to the sound level adjustment portion 64) adjusts the sound levels (volume) of the L-, C-, and R-direction signals respectively on the basis of the control value information, that is, on the basis of the control values set for those direction signals respectively, and thereby generates a playback sound signal from the direction signals having undergone sound level adjustment. The speaker portion 17 outputs the playback sound signal in the form of sound. The speaker portion 17 may be one provided external to (outside) the image shooting apparatus 1.

Let the L-, C-, and R-direction signals at time point t before sound level adjustment be represented by L(t), C(t), and R(t) respectively, and let the L-, C-, and R-direction signals at time point t after sound level adjustment be represented by L′(t), C′(t), and R′(t). Depending on the control values, it is possible that L(t)=L′(t), or that C(t)=C′(t), or that R(t)=R′(t). When the control value for the L-direction signal equals zero, the sound level of the L-direction signal does not change between before and after sound level adjustment; when the control value for the L-direction signal is positive, sound level adjustment causes the sound level of the L-direction signal to increase; when the control value for the L-direction signal is negative, sound level adjustment causes the sound level of the L-direction signal to decrease. A similar description applies to the C- and R-direction signals.

The playback sound signal is, for example, a monaural sound signal obtained by simply adding up the L-, C-, and R-direction signals after sound level adjustment. In this case, the playback sound signal, which is a monaural signal, at time point t is represented by “L′(t)+C′(t)+R′(t).”

Alternatively, for example, the playback sound signal may be a multiple-channel signal that has the L-, C-, and R-direction signals after sound level adjustment as sound signals worth 3 channels. In this case, providing the speaker portion 17 with an L-channel speaker for replaying the L-direction signal, an C-channel speaker for replaying the C-direction signal, and an R-channel speaker for replaying the R-direction signal makes it possible to replay the direction signals after sound level adjustment from the different channel speakers respectively.

In a case where the speaker portion 17 is a stereophonic speaker system composed L- and R-side speakers, from the L-, C-, and R-direction signals after sound level adjustment, L and R output signals may be generated as sound signals worth 2 channels so that a stereophonic sound signal composed of the L and R output signals is generated as the playback sound signal. In this case, the L and R output signals are replayed on the L- and R-side speakers respectively.

When the playback sound signal is replayed on the speaker portion 17, the target input image is replayed on the display potion 16 (that is, it is displayed on the display potion 16). At this time, the control value setting portion 63 appropriately sets the control values for the individual direction signals, and this permits the replay of a sound signal that suits the focus condition of the playback image.

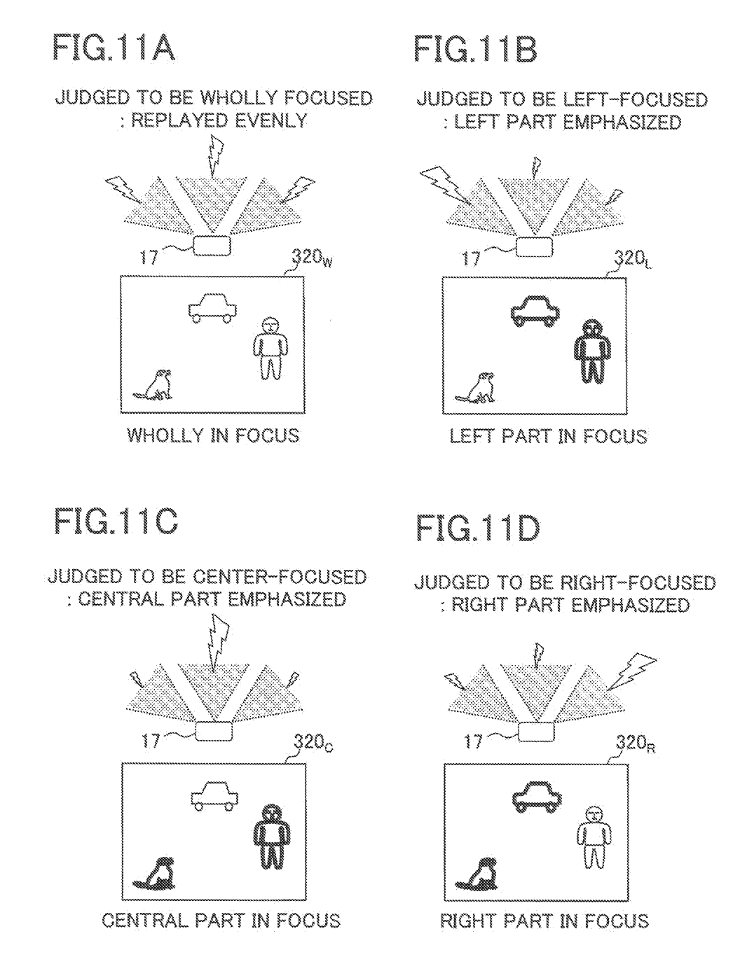

Now, a case where the target input image is like the one 320 shown in FIGS. 7A and 9 is taken up as an example, and with reference to FIG. 11A etc., a description will be given of an example of a method of setting the control values.

For example, if, on the basis of the in-focus position contained in the focus condition information, it is recognized that the entire image region of the target input image 320 is itself an in-focus region, or it is recognized that the divided image regions 321L, 321C, and 321R all include an in-focus region, then the control value setting portion 63 judges the target input image 320 to be wholly focused (wholly in-focus). FIG. 11A is a conceptual diagram of when a “wholly focused” judgment is made. The image 320_{W} in FIG. 11A represents the target input image 320 as it is judged to be wholly focused.

On making a “wholly focused” judgment, the control value setting portion 63 sets the control values for the L-, C-, and R-direction signals all at zero. In this case, the sound levels of the individual direction signals do not change between before and after the sound level adjustment by the sound level adjustment portion 64. Specifically, L(t)=L′(t), C(t)=C′(t), and R(t)=R′(t). Accordingly, when a “wholly focused” judgment is made, the sound from sound sources in areas 350L, 350C, and 350R is replayed evenly (see also FIG. 8). In a situation where a “wholly focused” judgment is made, it is considered that the entire playback image is attracting the viewer's interest, or it is unlikely that a particular part of the playback image is attracting the viewer's interest. Accordingly, replaying sound evenly is considered to best suit the playback image.

For another example, if, on the basis of the in-focus position contained in the focus condition information, it is recognized that the divided image region 321L of the target input image 320 is itself an in-focus region, or it is recognized that the divided image region 321L alone includes an in-focus region, then the control value setting portion 63 judges the target input image 320 to be left-focused (in focus in a left part). FIG. 11B is a conceptual diagram of when a “left-focused” judgment is made. The image 320_{L} in FIG. 11 B represents the target input image 320 as it is judged to be left-focused. In FIG. 11B, whichever object appears blurred in the image 320_{L} is indicated by a thickened outline (a similar description applies to FIGS. 11C, 11D, etc.).

On making a “left-focused” judgment, the control value setting portion 63, on one hand, sets the control value for the L-direction signal at a positive value and, on the other hand, sets the control values for the C- and R-direction signals at zero or a negative value. This causes, through the sound level adjustment by the sound level adjustment portion 64, the sound level of the L-direction signal to increase and the sound levels of the C- and R-direction signals to decrease. Instead, the control value setting portion 63 may, on one hand, set the control value for the L-direction signal at zero and, on the other hand, set the control values for the C- and R-direction signals at a negative value. This causes the sound level of the L-direction signal to increase relative to the sound levels of the C- and R-direction signals. In any case, when a “left-focused” judgment is made, in the playback sound signal, the sound from a sound source in area 350L corresponding to a subject in the divided image region 321L is emphasized (see also FIGS. 8 and 9). In a situation where a “left-focused” judgment is made, it is likely that a subject located in a left part of the playback image is attracting the viewer's interest. Accordingly, the sound level adjustment is performed in such a way that the sound from a subject located in a left part of the playback image is emphasized (a similar description applies to a “center-focused” judgment and a “right-focused” judgment, which will be described later).

For yet another example, if, on the basis of the in-focus position contained in the focus condition information, it is recognized that the divided image region 321C of the target input image 320 is itself an in-focus region, or it is recognized that the divided image region 321C alone includes an in-focus region, then the control value setting portion 63 judges the target input image 320 to be center-focused (in focus in a central part). FIG. 11C is a conceptual diagram of when a “center-focused” judgment is made. The image 320_{C} in FIG. 11C represents the target input image 320 as it is judged to be center-focused.

On making a “center-focused” judgment, the control value setting portion 63, on one hand, sets the control value for the C-direction signal at a positive value and, on the other hand, sets the control values for the L- and R-direction signals at zero or a negative value. This causes, through the sound level adjustment by the sound level adjustment portion 64, the sound level of the C-direction signal to increase and the sound levels of the L- and R-direction signals to decrease. Instead, the control value setting portion 63 may, on one hand, set the control value for the C-direction signal at zero and, on the other hand, set the control values for the L- and R-direction signals at a negative value. This causes the sound level of the C-direction signal to increase relative to the sound levels of the L- and R-direction signals. In any case, when a “center-focused” judgment is made, in the playback sound signal, the sound from a sound source in area 350C corresponding to a subject in the divided image region 321C is emphasized (see also FIGS. 8 and 9).

For yet another example, if, on the basis of the in-focus position contained in the focus condition information, it is recognized that the divided image region 321R of the target input image 320 is itself an in-focus region, or it is recognized that the divided image region 321R alone includes an in-focus region, then the control value setting portion 63 judges the target input image 320 to be right-focused (in focus in a right part). FIG. 11D is a conceptual diagram of when a “right-focused” judgment is made. The image 320_{R} in FIG. 11D represents the target input image 320 as it is judged to be right-focused.

On making a “right-focused” judgment, the control value setting portion 63, on one hand, sets the control value for the R-direction signal at a positive value and, on the other hand, sets the control values for the L- and C-direction signals at zero or a negative value. This causes, through the sound level adjustment by the sound level adjustment portion 64, the sound level of the R-direction signal to increase and the sound levels of the L- and C-direction signals to decrease. Instead, the control value setting portion 63 may, on one hand, set the control value for the R-direction signal at zero and, on the other hand, set the control values for the L- and C-direction signals at a negative value. This causes the sound level of the R-direction signal to increase relative to the sound levels of the L- and C-direction signals. In any case, when a “right-focused” judgment is made, in the playback sound signal, the sound from a sound source in area 350R corresponding to a subject in the divided image region 321R is emphasized (see also FIGS. 8 and 9).

Alternatively, when the depth of field (the interval between the near and far ends of the depth of field) contained in the focus condition information is greater than a predetermined reference depth, the target input image 320 may be judged to be wholly focused, and, on the other hand, when the depth of field (the interval between the near and far ends of the depth of field) contained in the focus condition information is smaller than the predetermined reference depth, the target input image 320 may be judged to be focused otherwise, namely either left-focused, center-forced, or right-focused (whether it is left-focused, center-forced, or right-focused is determined by the method described above). In this case, depending on whether the depth of field (the interval between the near and far ends of the depth of field) is greater or smaller than a reference depth TH_{DEPTH}, the control values are set differently, and thus the sound level adjustment portion 64 performs sound signal processing differently.

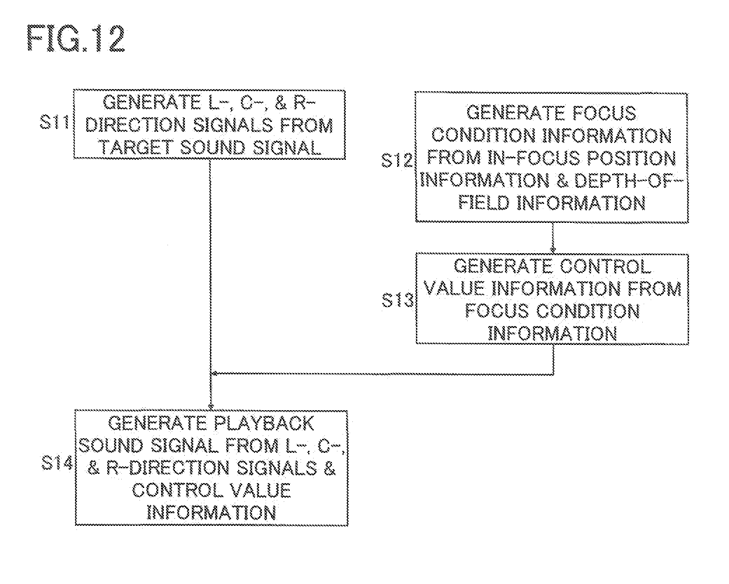

FIG. 12 is a flow chart of the operation for generating the playback sound signal. The generation of the playback sound signal requires the execution of processing at steps S11 through S14. At step S11, from a target sound signal, L-, C-, and R-direction signals are generated. At step S12, from in-focus position information and depth-of-field information, focus condition information is generated. At step S13, from the focus condition information, control value information is generated. At step S14, from the L-, C-, and R-direction signals and the control value information, a playback sound signal is generated.

It is possible to execute all the processing at steps S11 through S14 in the shooting mode and record the obtained playback sound signal to the recording medium 19 in a form associated with the image data of the target input image. In this case, by reading out from the recording medium 19 the playback sound signal along with the image data of the target input image, it is possible to replay the target input image along with the playback sound signal.

The processing at individual steps S11 to S14, however, may be executed with arbitrary timing, and the recording of information or a signal to the recording medium 19 may be inserted somewhere in the course of executing all the processing at steps S11 through S14.

Specifically, in one example, the target sound signal, the in-focus position information, and the depth-of-field information are recorded to the recording medium 19 in a form associated with the image data of the target input image; when necessary, the target sound signal, the in-focus position information, and the depth-of-field information are read out from the recording medium 19, and the processing at steps S11 through S14 is executed.

Likewise, in another example, the target sound signal is recorded to the recording medium 19 in a form associated with the image data of the target input image; when necessary, the target sound signal is read out from the recording medium 19, and the processing at step S11 is executed. At this time, if the control value information has been acquired, the processing at step S14 can also be executed.

In yet another example, the in-focus position information and the depth-of-field information are recorded to the recording medium 19 in a form associated with the image data of the target input image; when necessary, the in-focus position information and the depth-of-field information are lead out from the recording medium 19, and the processing at steps S12 and S13 is executed. At this time, if the L-, C-, and R-direction signals have been acquired, the processing at step S14 can also be executed.

In still another example, the focus condition information is recorded to the recording medium 19 in a form associated with the image data of the target input image; when necessary, the focus condition information is read out from the recording medium 19, and the processing at step S13 is executed. At this time, if the L-, C-, and R-direction signals have been acquired, the processing at step S14 can also be executed.

In a further example, the L-, C-, and R-direction signals and the control value information are recorded to the recording medium 19 in a form associated with the image data of the target input image; when necessary, the L-, C-, and R-direction signals and the control value information are read out from the recording medium 19, and the processing at step S14 is executed.

As described above, in this embodiment, in accordance with the focus condition of the target input image, which is the playback image, the content of sound signal processing, that is, what is performed as sound signal processing, to generate a playback sound signal from the target sound signal is controlled. At this time, a region that is supposed to be attracting the viewer's interest is identified in accordance with the focus state of the playback image, and the sound corresponding to that region is replayed with emphasis. This makes it possible to replay a sound signal in a manner that suits the viewer's interest. Such replaying of sound is realized without special operation by the user, and is therefore extremely useful. For example, with a playback image that has a comparatively small depth of field and has an in-focus region limited to a particular region, the viewer's attention concentrates in the in-focus region; accordingly, a sound signal reaching from the in-focus region is replayed with emphasis (see FIGS. 11B, 11C, and 11D). On the other hand, with a playback image that has a comparatively great depth of field and is wholly focused, sound from a wide range is replayed evenly (see FIG. 11A).

The target input image may be an image acquired by shooting using AF control (automatic focusing control), or an image acquired by shooting using MF control (manual focusing control). Whereas when AF control is used, the focal length is determined by the AF control executed by the image shooting apparatus 1, when MF control is used, the focal length is determined as the user specifies it. Between AF and MF control, the only difference is what (who) determines the focal length, and there is no difference in the operation of the blocks involved shown in FIG. 6.

The L-, C-, and R-direction signals may be generated by a method other than that described above involving directivity control. For example, it is possible to use a method of separating and extracting, from output sound signals of a plurality of microphones, sound signals from different sound sources spread in space on a sound-source-by-sound-source basis (for example, the methods disclosed in JP-A-2000-81900 and JP-A-H10-313497). In this case, quite naturally, in the course of separation and extraction, the angle θ of each sound source is recognized. Thus, on the basis of the results of the recognition, the individual direction signals can be generated in such a way that the L-direction signal contains the sound signal from a sound source in area 350L, that the C-direction signal contains the sound signal from a sound source in area 350C, and that the R-direction signal contains the sound signal from a sound source in area 350R.

For another example, it is possible to provide the microphone portion 14 with a microphone having first directivity which exhibits high sensitivity to the sound from a sound source in area 350L, a microphone having second directivity which exhibits high sensitivity to the sound from a sound source in area 350C, and a microphone having third directivity which exhibits high sensitivity to the sound from a sound source in area 350R, so that from the microphones having the first to third directivity, the L-, C-, and R-direction signals are obtained directly. In this case, from the three sound signals obtained by sound collection by the microphones having the first to third directivity, the target sound signal is generated. With respect to the microphone having the first directivity, saying that it “exhibits high sensitivity to the sound from a sound source in area 350L” means that it “exhibits higher sensitivity to the sound from a sound source in area 350L than to the sound from a sound source outside area 350L (a similar description applies to the microphones having the second and third directivity).

Although the above description deals with operation performed in a case where the number of direction signals generated by the sound source separation portion 61 is three, the number may be any other so long as it is 2 or more.

### Embodiment 2

A second embodiment (Embodiment 2), of the invention will be described. Embodiment 2 is an embodiment based on Embodiment 1, and accordingly, for the aspects of Embodiment 2 that are not specifically discussed in the following description, the corresponding parts of the description of Embodiment 1 equally apply to Embodiment 2 unless inconsistent. An image shooting apparatus 1 according to Embodiment 2 is provided with a function of changing the focus condition (such as the in-focus distance, the depth of field, etc.) of the target input image by image processing after the acquisition of the image data of the target input image by shooting. The processing for achieving this function is called digital focusing.

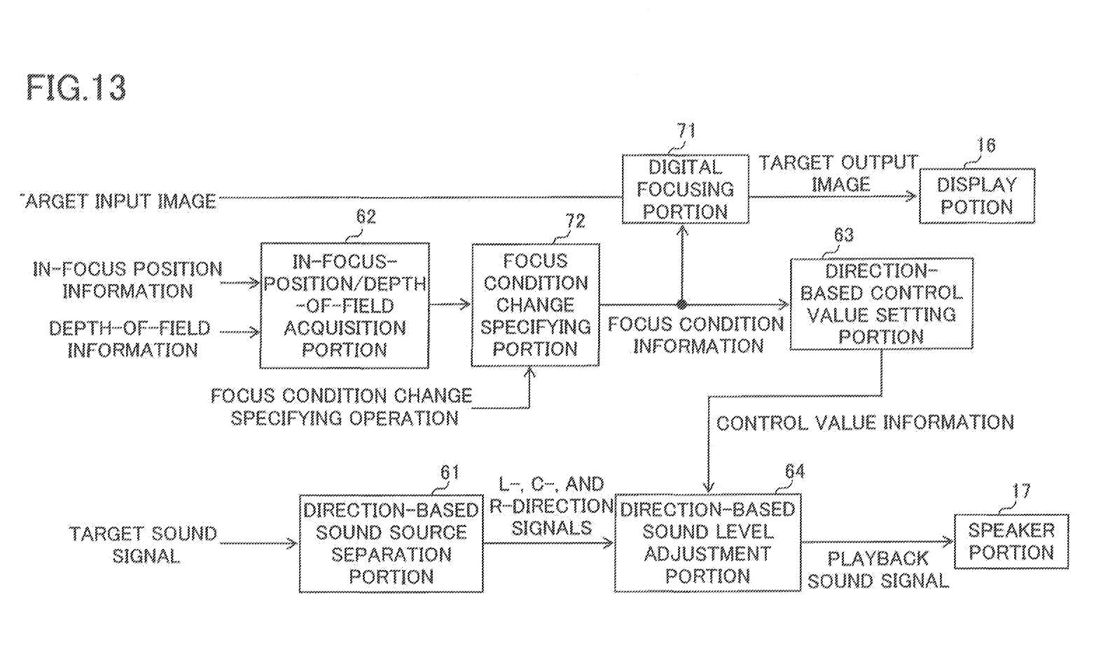

FIG. 13 is a block diagram of the blocks particularly involved in the function of changing the focus condition of the target input image and a function of applying special sound signal processing in accordance with the focus condition. The blocks identified by the reference signs 61 to 64 in FIG. 13 are the same as those in FIG. 6. A digital focusing portion 71 can be provided in the image processing portion 13 in FIG. 1. A focus condition change specifying portion 72 is realized by the image processing portion 13 and/or the main controller portion 20 in FIG. 1.

The digital focusing portion (image processing portion) 71 changes the focus condition of the target input image. The target input image that has its focus condition changed is called the target output image. The digital focusing portion 71 can change the focus condition of the target input image in terms of at least one of the in-focus position, the in-focus distance, the depth of field (the interval between the near and far ends of the depth of field), and the degree of focus.

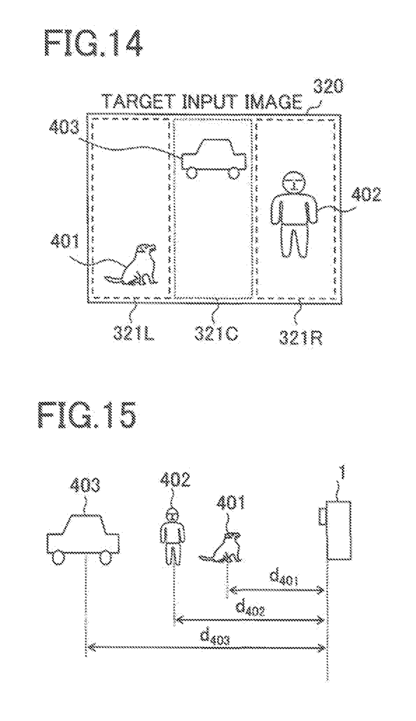

Now, the target input image 320 shown in FIG. 9 is taken up as an example, and with reference to FIG. 14 etc., a description will be given of the definition of changing the focus condition. FIG. 14 shows the same target input image 320 as that shown in FIG. 9. The divided image regions 321L, 321C, and 321L of the target input image 320 contain the image data of a dog as a subject 401, an automobile as a subject 403, and a person as a subject 402 respectively. Moreover, it is assumed that, as shown in FIG. 15, the subject distances of the subjects 401, 402, and 403 during the shooting of the target input image 320 are represented by d₄₀₁, d₄₀₂, and d₄₀₃ respectively. Here, it is assumed that d₄₀₁<d₄₀₂<d₄₀₃.

Suppose that, during the shooting of the target input image 320, the subject distance d₄₀₁ equals the in-focus distance, and let this state be called state ST₄₀₁. It is here assumed that the depth of field of the target input image 320 shot in state ST₄₀₁ does not include the subject distances d₄₀₂, and d₄₀₃. The image 320_{L} in FIG. 11B corresponds to the target input image 320 shot in state ST₄₀₁.

Suppose that, during the shooting of the target input image 320, the subject distance d₄₀₂ equals the in-focus distance, and let this state be called state ST₄₀₂. It is here assumed that the depth of field of the target input image 320 shot in state ST₄₀₂ does not include the subject distances d₄₀₁ and d₄₀₃. The image 320_{R} in FIG. 11D corresponds to the target input image 320 shot in state ST₄₀₂.

Suppose that, during the shooting of the target input image 320, the subject distance d₄₀₃ equals the in-focus distance, and let this state be called state ST₄₀₃. It is here assumed that the depth of field of the target input image 320 shot in state ST₄₀₃ does not include the subject distances d₄₀₁ and d₄₀₂. The image 320_{C} in FIG. 11C corresponds to the target input image 320 shot in state ST₄₀₃.

Suppose that, during the shooting of the target input image 320, the depth of field includes all the subject distances ST₄₀₁ to ST₄₀₃, and let this state be called state ST_{W}. The image 320_{W}in FIG. 11A corresponds to the target input image 320 shot in state ST_{W}.

A few examples of patterns in which digital focusing is executed will now be described.

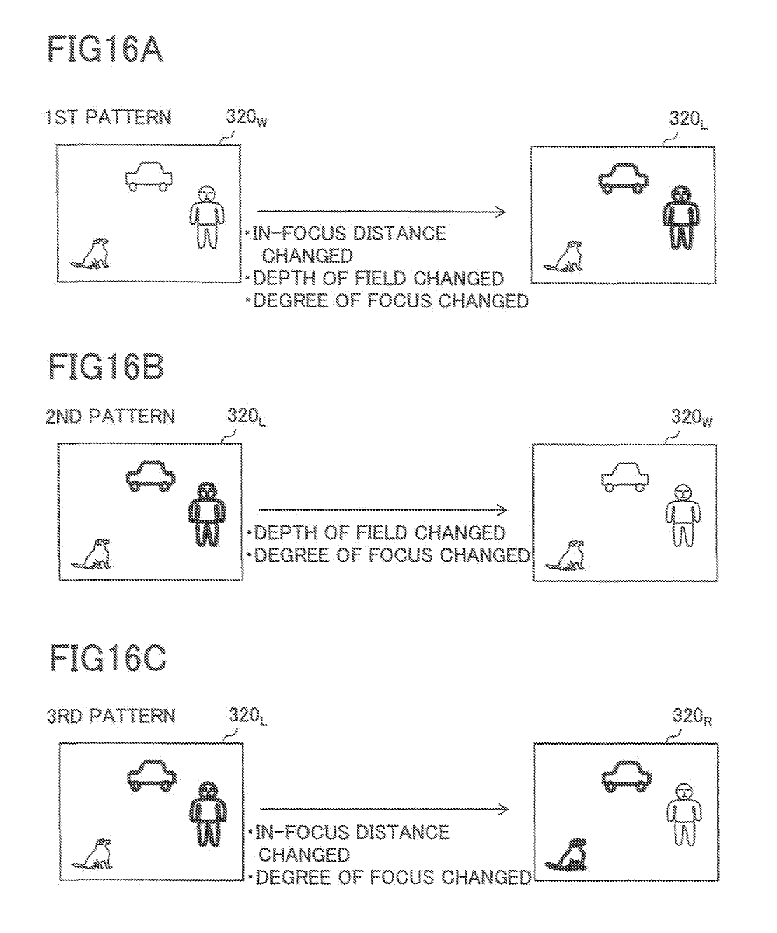

FIG. 16A is a conceptual diagram of digital focusing executed in a first pattern. In the first pattern, from the target input image 320_{W} obtained by shooting in state ST_{W}, through digital focusing, the image 320_{L} is generated as the target output image. To achieve that, the digital focusing portion 71 decreases the in-focus distance of the target input image 320_{W}, or decreases the depth of field (the interval between the near and far ends of the depth of field) of the target input image 320_{W}, or does both, in such a way that, in the target output image, only the subject distance d₄₀₁ out of the subject distances d₄₀₀ to d₄₀₃ falls within the depth of field. Instead, the digital focusing portion 71 may perform such image processing as to reduce the degree of focus in the divided image regions 321C and 321R of the target input image 320_{W} in such a way that, in the target output image, only the subject distance d₄₀₁ out of the subject distances d₄₀₁ to d₄₀₃ falls within the depth of field. In the first pattern, changing the in-focus distance etc. causes the in-focus region to change from the entire image to a region in a left part of the image, and as the in-focus region is so changed, the in-focus position is changed as well.

FIG. 16B is a conceptual diagram of digital focusing executed in a second pattern. In the second pattern, from the target input image 320_{L} obtained by shooting in state ST₄₀₁, through digital focusing, the image 320_{W} is generated as the target output image. To achieve that, the digital focusing portion 71 increases the depth of field (the interval between the near and far ends of the depth of field) of the target input image 320_{L} in such a way that, in the target output image, all the subject distances d₄₀₁ to d₄₀₃ fall within the depth of field. Instead, the digital focusing portion 71 may perform such image processing as to increase the degree of focus in the divided image regions 321C and 321R of the target input image 320_{L} in such a way that, in the target output image, all the subject distances d₄₀₁ to d₄₀₃ fall within the depth of field. In the second pattern, changing the depth of field etc. causes the in-focus region to change from a region in a left part of the image to the entire image, and as the in-focus region is so changed, the in-focus position is changed as well.

FIG. 16C is a conceptual diagram of digital focusing executed in a third pattern. In the third pattern, from the target input image 320_{L} obtained by shooting in state ST₄₀₁, through digital focusing, the image 320_{R} is generated as the target output image. To achieve that, the digital focusing portion 71 increases the in-focus distance of the target input image 320_{L} in such a way that, in the target output image, only the subject distance d₄₀₂ out of the subject distances d₄₀₁ to d₄₀₃ falls within the depth of field. Simultaneously with this increasing, if necessary, the depth of field (the interval between the near and far ends of the depth of field) may be changed as well. Instead, the digital focusing portion 71 may perform such image processing as to reduce the degree of focus in the divided image region 321L of the target input image 320_{L} and to increase the degree of focus in the divided image region 321R of the target input image 320_{L} in such a way that, in the target output image, only the subject distance d₄₀₂ out of the subject distances d₄₀₁ to d₄₀₃ falls within the depth of field. In the third pattern, changing the in-focus distance etc. causes the in-focus region to change from a region in a left part of the image to a region in a right part of the image, and as the in-focus region is so changed, the in-focus position is changed as well.

As a method of changing the in-focus distance and depth of field (the interval between the near and far ends of the depth of field) of the target input image, the digital focusing portion 71 can use any methods including well-known methods. It is possible to use, for example, a method called “light field photography” (hereinafter called a light field method). By use of a light field method, it is possible to generate from the target input image based on the output signal of the image sensor 33 a target output image having a desired in-focus distance and depth of field (the interval between the near and far ends of the depth of field). Here, any well-known method based on a light field method can be used (for example, the method described in WO 2006/039486 or the method described in JPA-2009-224982). According to a light field method, by use of an image-shooting lens having an aperture stop combined with a microlens array, the image signal (image data) obtained from an image sensor is made to contain, in addition to the light intensity distribution on the light-receiving surface of the image sensor, information on traveling directions of light. An image shooting apparatus adopting a light field method can, by performing image processing based on the image signal from an image sensor, reconstruct an image having a desired in-focus distance and depth of field (the interval between the near and far ends of the depth of field). That is, by use of a light field method, after the shooting of a target input image, it is possible to freely reconstruct from it a target output image in which a desired subject is in focus.

Accordingly, although not shown in FIG. 2, when a light field method is used, an optical component needed to realize it is provided in the image shooting portion 11. This optical component includes a microlens array etc., and the light from the subject is incident on the light-receiving surface (in other words, the image-sensing surface) of the image sensor 33 via the microlens array etc. The microlens array is composed of a plurality of microlenses, of which each is allocated to one or a plurality of light-receiving pixels on the image sensor 33. Thus, the output signal of the image sensor 33 contains, in addition to the light intensity distribution on the light-receiving surface of the image sensor 33, information on the traveling directions of the light incident on the image sensor 33. By use of the image data of the target input image which thus contains that information, the digital focusing portion 71 can freely change the in-focus distance and depth of field (the interval between the near and far ends of the depth of field) of the target input image.

The digital focusing portion 71 may perform digital focusing by a method that is not based on a light field method. As an example, a method of changing the degree of focus after the shooting of a target input image will be described below in relation to the first to third patterns.

As described above, in the first pattern, the digital focusing portion 71 may perform such image processing as to reduce the degree of focus in the divided image regions 321C and 321R of the target input image 320_{W} in order to thereby generate the target output image 320_{L}. Specifically, for example, the divided image regions 321C and 321R of the target input image 320_{W} are set as a processing target region, and blurring processing is executed to blur the image inside the processing target region. The blurring processing can be achieved by spatial domain filtering using an averaging filter, a weighted-averaging filter, a Gaussian filter, or the like, or by frequency filtering using a low-pass filter.

As described above, in the second pattern, the digital focusing portion 71 may perform such image processing as to increase the degree of focus in the divided image regions 321C and 321R of the target input image 320_{L} in order to thereby generate the target output image 320_{W}. To achieve that, the divided image regions 321C and 321R of the target input image 320_{L} are set as a processing target region, and image restoration (deconvolution) processing for undoing deterioration (convolution) ascribable to blur in the image inside the processing target region is included in digital focusing. By the image restoration processing, the blur of the image inside the processing target region is removed, and the processing target region comes to be included in the in-focus region (that is, the target output image 320_{W} is obtained). The image restoration processing may be achieved by a well-known method. The image restoration processing may be executed not only by use of the image data of the target input image but also that of one or more frame images shot temporally close to the target input image.

As described above, in the third pattern, the digital focusing portion 71 may perform such image processing as to reduce the degree of focus in the divided image region 321L of the target input image 320_{L} and to increase the degree of focus in the divided image region 321R of the target input image 320_{L} in order to thereby generate the target output image 320_{R}. To achieve that, the above-mentioned blurring processing, here with the divided image region 321L of the target input image 320_{L} set as a processing target region, and the above-mentioned image restoration processing, here with the divided image region 321R of the target input image 320_{L} set as a processing target region, are executed in a form included in digital focusing.

Information specifying how to change the focus condition of the target input image at the digital focusing portion 71 is output as focus condition information from the focus condition change specifying portion 72 (hereinafter often abbreviated to the specifying portion 72) in FIG. 13. The focus condition information output from the specifying portion 72 is generated based on operation by the user. An operation performed by the user to specify a change in the focus condition of the target input image is called a focus condition change specifying operation.

A manner of use that is considered to be typical is as follows: after a target input image is shot and stored on the recording medium 19, in the playback mode, the target input image read out from the recording medium 19 is fed to the digital focusing portion 71. Here, when a focus condition change specifying operation is performed, the specifying portion 72 generates focus condition information in accordance with what is performed as the focus condition change specifying operation, and outputs it to the digital focusing portion 71 and the control value setting portion 63. The specifying portion 72 can generate the focus condition information it outputs on the basis of the output of the acquisition portion 62. The digital focusing portion 71 generates from the target input image a target output image by digital focusing in accordance with the focus condition information from the specifying portion 72.

The control value setting portion 63, so long as no focus condition change specifying operation is performed, generates control value information on the basis of the focus condition information output from the acquisition portion 62 as described previously in connection with Embodiment 1 but, when a focus condition change specifying operation is performed, generates control value information on the basis of the focus condition information output from the specifying portion 72. The focus condition information output from the specifying portion 72 contains information conveying the in-focus position and depth of field of the target output image. Accordingly, when a focus condition change specifying operation is performed, the control value setting portion 63 generates control value information by operation similar to that in Embodiment 1 on the basis of the in-focus position and depth of field (the interval between the near and far ends of the depth of field) of the target output image. That is, it generates control value information by use of, instead of the in-focus position and depth of field (the interval between the near and far ends of the depth of field) of the target input image, the in-focus position and depth of field (the interval between the near and far ends of the depth of field) of the target output image. The operation of the sound source separation portion 61 and the operation of the sound level adjustment portion 64 on the basis of the control value information are as described previously in connection with Embodiment 1.

When the playback sound signal is replayed on the speaker portion 17, the target output image is replayed on the display potion 16 (that is, it is displayed on the display potion 16). At this time, by the operation of the sound level adjustment portion 64 etc., a sound signal that suits the focus condition of the playback image is replayed.

For example, when, as in the first pattern in FIG. 16A, the target output image 320_{L} is generated according to a focus condition change specifying operation, control value information similar to that generated when a “left-focused” judgment is made is generated (see FIG. 11B); thus, in the playback sound signal, the sound from a sound source in area 350L corresponding to a subject in the divided image region 321L is emphasized (see also FIGS. 8 and 9).

For another example, when, as in the second pattern in FIG. 16B, the target output image 320_{W} is generated according to a focus condition change specifying operation, control value information similar to that generated when a “wholly focused” judgment is made is generated (see FIG. 11A); thus, the sound from sound sources in areas 350L, 350C, and 350R is replayed evenly (see also FIG. 8).

For yet another example, when, as in the third pattern in FIG. 16C, the target output image 320_{R} is generated according to a focus condition change specifying operation, control value information similar to that generated when a “right-focused” judgment is made is generated (see FIG. 11D); thus, in the playback sound signal, the sound from a sound source in area 350R corresponding to a subject in the divided image region 321R is emphasized (see also FIGS. 8 and 9).

When the user performs an operation specifying a change in the depth of field etc., the sound level is adjusted direction by direction to suit the changed playback image. This is because replaying a sound signal in accordance with the changed depth of field etc. matches the viewer's interest. That is, through the sound level adjustment described above, it is possible to replay a sound signal in a manner that suits the viewer's interest.

### Variations and Modifications

Embodiments of the invention accommodate many variations and modifications made within the scope of the technical ideas set forth in the appended claims. The embodiments specifically described above are merely examples of how the invention can be carried out, and the definitions of the terms used to describe the invention and its constituent features are not limited to those given in the description of the embodiments above. Any specific values mentioned in the above description are merely examples and, quite naturally, they may be changed as desired. Supplementary description applicable to the embodiments described above is given below as Notes 1 to 4. Unless inconsistent, features from different notes can be combined together as desired.

Note 1: In the embodiments described above, sound signal processing for generating a playback sound signal and digital focusing are executed on the image shooting apparatus 1; these may instead be executed on an electronic device (not shown) separate from the image shooting apparatus 1. The electronic device here may be, for example, an information terminal device such as a personal computer or a PDA (personal digital assistant), and preferably is provided with a function of replaying image and sound signals. The image shooting apparatus 1 itself is a kind of electronic device. By providing such an electronic device with, for example, the individual blocks shown in FIG. 6 or the individual blocks shown in FIG. 13, and feeding the electronic device with the image data of a target input image, a target sound signal, and information necessary to derive focus condition information, it is possible to generate a playback sound signal on that electronic device, and further to generate a target output image as well.

Note 2: In the embodiments described above, after L-, C-, and R-direction signals are generated from a target sound signal, sound level adjustment is performed on the L-, C-, and R-direction signals, and then a playback sound signal (for example, a playback sound signal having directivity in a particular direction) is generated. However, so long as a playback sound signal like the one described above is obtained in accordance with the focus condition, the processing method by which the playback sound signal is generated from the target sound signal is not limited to that described above.

For example, in Embodiment 1, when the target input image is judged to be “left-focused” (see FIG. 11B), only the L-direction signal may be extracted from the target sound signal by directivity control so that the extracted L-direction signal is output as the playback sound signal (in this case, no C- or R-direction signal is generated). In this case, the playback sound signal exhibits high sensitivity in the direction of a sound source in area 350L but, so long as directivity characteristics are adjusted properly, it also contains a fraction of sound components from sound sources in areas 350C and 350R.

Note 3: In the embodiments described above, it is mainly assumed that the microphone portion 14 is composed of two microphones 14L and 14R; instead, it is also possible to adopt as the microphone portion 14 a microphone array (not shown) composed of three or more microphones so as to generate a target sound signal by sound collection by the microphone array. In that case, the playback sound signal is generated by controlling the directivity of the microphone array in accordance with the focus condition of a target input image or a target output image.

Note 4: The image shooting apparatus 1 in FIG. 1 or the electronic device mentioned above may be implemented in hardware or in a combination of hardware and software. In a case where the image shooting apparatus 1 or the electronic device mentioned above is implemented in software, a block diagram of the part realized with software serves as a functional block diagram of that part. The functions to be realized with software may be prepared in the form of a program so that, when the program is executed on a program executing apparatus (for example, a computer), those functions are realized.

What is claimed is:

1. An electronic device comprising a sound signal processing portion which applies sound signal processing to a target sound signal corresponding to a target image,
wherein the sound signal processing portion controls content of the sound signal processing in accordance with a focus condition of the target image.

2. The electronic device according to claim 1, further comprising an in-focus position acquisition portion which acquires as an in-focus position a position, on the target image, of an in-focus region where image data of an object in focus is present,
wherein the sound signal processing portion controls the content of the sound signal processing in accordance with the in-focus position.

3. The electronic device according to claim 2,
wherein the sound signal processing portion applies the sound signal processing to the target sound signal such that sound from a sound source at the in-focus position is emphasized.

4. The electronic device according to claim 2, wherein
the focus condition includes a depth of field of the target image, and
the sound signal processing portion controls the content of the sound signal processing in accordance with the in-focus position and the depth of field.

5. The electronic device according to claim 4,
wherein the sound signal processing portion changes the content of the sound signal processing between when the depth of field is comparatively great and when the depth of field is comparatively small.

6. The electronic device according to claim 1, further comprising an image processing portion which changes the focus condition of the target image by image processing,
wherein, when the focus condition of the target image is changed, the sound signal processing portion controls the content of the sound signal processing in accordance with the changed focus condition.
